(19) United States
(12) Patent Application Publication
(10) Pub. No.: US 2018/0345847 A1
(43) Pub. Date: Dec. 6, 2018

(54) ADJUSTMENT OF A LUMINOUS INTENSITY OF HEADLAMP LIGHT OF A VEHICLE

(71) Applicant: OSRAM GmbH, Munich (DE)

(72) Inventors: Daniel Weissenberger, Giengen (DE); Thomas Feil, lggingen (DE); Roland Fiederling, Friedberg (DE)

(21) Appl. No.: 15/980,801

(22) Filed: May 16, 2018

(30) Foreign Application Priority Data
Jun. 1, 2017 (DE) 10 2017 209 301.3

(51) Int. Cl. B60Q 1/14; F21S 41/141; F21S 41/125; H05B 33/08

(52) U.S. Cl. CPC B60Q 1/1415; F21S 41/141; H05B 33/0857; H05B 33/0845; F21S 41/125

(57) ABSTRACT

A method for adjusting a luminous intensity of headlamp light of a vehicle is provided. The vehicle includes at least one headlamp producing the headlamp light. The at least one headlamp includes a plurality of individually controllable light sources which create different partial areas of a light emission pattern of the headlamp light. The method includes obtaining a ground geometry of a ground area which can be illuminated by the headlamp light in the vicinity of the vehicle, calculating an illuminance producible by each of the light sources on the ground area using the obtained ground geometry, comparing the calculated illuminances with respective reference values, and adjusting a luminous intensity of the light sources to achieve the associated reference values of the illuminance.

### CROSS-REFERENCE TO RELATED APPLICATION

This application claims priority to German Patent Application Serial No. 10 2017 209 301.3, which was filed Jun. 1, 2017, and is incorporated herein by reference in its entirety.

### TECHNICAL FIELD

Various embodiments relate generally to a method for adjusting a luminous intensity of headlamp light of a vehicle, wherein the vehicle has at least one headlamp producing the headlamp light and at least one headlamp has a plurality of individually controllable light sources which create different partial areas of a light emission pattern of the headlamp. Various embodiments are applicable, for example, to an illumination of a ground area in front of a vehicle, e.g. in front of a motor vehicle.

### BACKGROUND

In the case of vehicle headlamps with light sources disposed in the form of a matrix, a light distribution of the headlamp light emitted or produced by the headlamp is normally created by a superimposition of individual light distributions or individual light beams which are produced by a plurality of light modules, each with a plurality of light sources. In the simplest case, two light modules are present, i.e. in each case one in a right-side headlamp and one in a left-side headlamp. A plurality of light modules which are at a spatial distance from one another may also be present for each headlamp.

### SUMMARY

A method for adjusting a luminous intensity of headlamp light of a vehicle is provided. The vehicle includes at least one headlamp producing the headlamp light. The at least one headlamp includes a plurality of individually controllable light sources which create different partial areas of a light emission pattern of the headlamp light. The method includes obtaining a ground geometry of a ground area which can be illuminated by the headlamp light in the vicinity of the vehicle, calculating an illuminance producible by each of the light sources on the ground area using the obtained ground geometry, comparing the calculated illuminances with respective reference values, and adjusting a luminous intensity of the light sources to achieve the associated reference values of the illuminance.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a sectional representation in side view of a vehicle located on a first, flat roadway;

FIG. 2 shows a top view of the vehicle from FIG.1 located on the first roadway together with a light emission pattern emitted onto the first roadway;

FIG. 3 shows a sectional representation in side view of the vehicle from FIG. 1 on a second roadway ascending in front of the vehicle; and

FIG. 4 shows a top view of the vehicle from FIG. 1 located on the second roadway together with the light emission pattern now emitted onto the second roadway.

### DESCRIPTION

The following detailed description refers to the accompanying drawings that show, by way of illustration, specific details and embodiments in which the invention may be practiced.

The characteristics, features and advantages of this invention described above and the manner in which they are achieved will become clearer and more readily understandable in conjunction with the following schematic description of an example embodiment which is explained in detail with reference to the drawings. Elements which are the same or which produce the same effect can be denoted with the same reference numbers for the sake of clarity.

Various embodiments may overcome, at least partially, the disadvantages of the prior art and, for example, to provide a facility for an improved illumination of a surrounding area of a vehicle.

Various embodiments provide a method for adjusting a luminous intensity of headlamp light of a vehicle, wherein the vehicle has at least one headlamp producing the headlamp light, at least one headlamp has a plurality of individually controllable light sources which create different partial areas of a light emission pattern of the headlamp light and wherein, in the method, a ground geometry of a ground area which can be illuminated by the headlamp light is obtained in the vicinity of the vehicle, an illuminance producible by each of the light sources on the ground area is calculated on the basis of the obtained ground geometry, the calculated illuminances are compared with respective reference values and a luminous intensity of the light sources is adjusted to achieve the associated reference values of the illuminance.

This method offers the effect that the illuminance in the surrounding area of the vehicle is adjustable on the basis of the dynamic adjustment of the luminous intensity locally according to the ground geometry. As a result, an illumination of the surrounding ground area which appears to be uniform to an occupant of the vehicle can in turn be achieved, in fact even if the geometry of said ground area changes. This in turn results in a gain in comfort and safety for the driver. The luminous intensity can thus be adjusted according to whether the ground geometry is flat or curved, horizontal or ascending, etc. If it is ascending, for example, the luminous intensity can be reduced at least locally in order to obtain an even illuminance.

The vehicle may be a motor vehicle (e.g. a motorized vehicle such as an automobile, truck, bus, etc., or a motorcycle), a bicycle or a rail train. The headlamp may be a front headlamp.

In one development, the light sources are semiconductor light sources. These are particularly compact and durable. In one development, the semiconductor light sources include or have at least one light-emitting diode. If a plurality of light-emitting diodes are provided, these can emit light in the same color or in different colors. A color may be monochrome (e.g. red, green, blue, etc.) or multichrome (e.g. white). A plurality of light-emitting diodes may produce a mixed light, e.g. a white mixed light. The at least one light-emitting diode may contain at least one wavelength-converting luminescent material (conversion LED). Alternatively or additionally, the luminescent material may be disposed at a distance from the light-emitting diode (“remote phosphor”). The at least one light-emitting diode may be present in the form of at least one individually housed light-emitting diode or in the form of at least one LED chip. A plurality of LED chips may be mounted on a common substrate (“submount”). The at least one light-emitting diode may be equipped with at least one dedicated and/or common optical system for beam guidance, e.g. at least one Fresnel lens, collimator, etc. Instead of or in addition to inorganic light-emitting diodes, e.g. based on InGaN or AlInGaP, organic LEDs (OLEDs, e.g. polymer LEDs) are generally also usable. Alternatively, the at least one semiconductor light source may have e.g. at least one diode laser.

A light source can generally be understood to mean a pixel-type light-producing surface. The pixel-type light-producing surface may be the (single) light emission surface of a light-producing element such as a semiconductor light source, e.g. an LED. However, a pixel-type light-producing surface may also be created by means of an LCD system of a DLP/DMD system or of a luminescent-material-scanning laser system (LARP=Laser Activated Remote Phosphor). Thus, in the case of an LCD system, for example, the individual pixels of the liquid crystal display which can be emitted by means of a light beam can be understood as pixel-type light-producing areas or light sources, in the case of a DLP system the individual micromirrors (DMD=Digital Mirror Display) can be understood as pixel-type light-producing areas or light sources, etc.

Individually controllable light sources can be understood to mean that that said light sources are controllable singly and/or in groups. The light beams produced by the single light sources and/or groups of light sources in each case create partial areas of the (total) light emission pattern of the headlamp. The partial areas, i.e. partial areas of light sources and/or groups of light sources of a single headlamp and/or partial areas of light sources and/or groups of light sources of different headlamps, may overlap or may be superimposed on one another.

The light sources may be disposed in the form of a matrix, e.g. as an (m×m) field, for example where m=32 or a multiple thereof. If the light sources are controllable in groups, the groups may also be disposed in the form of a matrix, e.g. as an (n×n) field where n<m, for example where n=4 or a multiple thereof.

In one development, a control of the light sources includes a dimming of the light sources. Dimming can be carried out to predefined dimming values (e.g. to 20%, 50%, 100%) or continuously. The dimming can be achieved in the case of PWM-controlled light sources by setting PWM values. Alternatively or additionally, an amplitude modulation can be carried out for this purpose. In the case of DLP systems, the dimming of a “light source” can be set by the duration during which a micromirror of the DLP system extracts light from the headlamp.

An area (“ground area”) located or disposed around the vehicle can be illuminated by means of the light emission pattern. A ground area has a three-dimensional topology or surface contour (“ground geometry”).

The calculation of the illuminance producible on the ground can be carried out solely on the basis of the geometric relationship of the light beams emitted by the headlamp and the ground geometry, e.g. on the basis of a distance and angular relationship between the headlamp and the ground geometry. The illuminance can be indicated in lumens per square meter (lm/m²). The luminous intensity can be indicated in candelas (cd) or lumens per steradian (lm/sr).

The reference values may be fixed predefined values and/or dynamically calculated values. They may correspond to a profile, i.e. may be locally variable.

In one design, a geometry of a roadway in front of the vehicle may be obtained by querying a database with geometry data in the area of a current position of the vehicle. As a result, a sensor system and evaluation device in the vehicle can advantageously be dispensed with. The database with geometry data may be a GPS-supported contour database or elevation database. The database may be stored in the vehicle and/or may be stored outside the vehicle. In the case of a storage outside the vehicle, the data can be transferred to the vehicle via a wireless data link.

In an alternative or additional design, the ground geometry can be obtained by measuring it by means of the vehicle. This offers the advantage that the acquisition of the ground geometry is particularly realistic and can be performed with particularly high spatial resolution. The measurement can be carried out by means of a camera, a radar rangefinder, a lidar rangefinder, a levelling sensor, etc.

In another development, a vehicle inclination, which can be measured, for example, by means of a levelling sensor, is included in the calculation of the relative arrangement of sensors, headlamps and ground geometry. This may be provided if the headlamps have a levelling adjustment as a result of which the relative arrangement of the headlamp and sensors in relation to one another can change.

In another design, a vehicle has at least one headlamp producing headlamp light, at least one headlamp has a plurality of individually controllable light sources which create different partial areas of a light emission pattern of the headlamp light, a luminance image of the light reflected by the ground is recorded, a partial image of the luminance image is assigned to each light source, the partial light sources are compared with respective reference values and a luminous intensity of the light sources is adjusted to achieve the associated reference values of the luminance. This design offers the advantage that a reflection or retroreflection characteristic of the ground is taken into account, i.e. whether the ground reflects light striking the ground locally more strongly or less strongly back onto the vehicle. This offers the effect that an illumination of the surrounding ground which appears to be particularly uniform to an occupant of the vehicle is achieved. For example, the luminous intensity can be adjusted according to whether the ground geometry has a road surface, vegetation, etc. In various embodiments, luminances can be adjusted to a specific ratio between a roadway or carriageway and the carriageway edge, for example so that a roadway is illuminated with a higher illuminance than a carriageway edge. This offers the effect that the driver's attention is directed toward the roadway, thereby increasing safety in road traffic. This design is also suitable for achieving the object on its own. However, it is particularly effective together with the adjustment of the illuminance.

The assignment of a partial image of the luminance image to a light source (or group of light sources) can be carried out on the basis of the measured ground geometry.

In various embodiments, a ground geometry of the ground area which can be illuminated by the headlamp light can be measured optically by means of the vehicle for this purpose.

The use of luminance images is essentially known, for example, from: Schwanz, B., Marutzky, M., Kleinert, B., Elsner, S., Bogdanow, S., IAV GmbH, Rockwellstraße 16, 38518 Gifhorn, “Messsystemanalyse eines Leuchtdichtekamera-basierten Scheinwerferprüstands” [“Measuring system analysis of a luminance-camera-based headlamp test rig”], Lux junior 2015, 12. Forum für den lichttechnischen Nachwuchs” [“12^{th} Forum for up-and-coming academics working in the field of lighting engineering”], 25 to 27 Sep. 2015 in Dörnfeld.

The luminance or a luminance image can be determined by means of a luminance sensor. The luminance sensor may be a luminance camera or a different luminance meter. The at least one light source used to produce the reflected light detected by the luminance sensor may be a light source of a headlamp. Alternatively or additionally, the luminance can be produced independently from an illumination by a headlamp, e.g. by means of a light source such as a laser, etc., used for this purpose only.

The luminance image can also be determined from a measurement of a local reflection behavior of the ground area concerned. The reflection behavior can be defined e.g. by means of lasers or by means of optical sensors.

The luminance can be indicated in units of cd/m². A desired reference luminance can also be achieved through a corresponding control of the light sources. Here also, the control of the light sources may include a dimming to predefined dimming values (e.g. to 20%, 50% or 100%) or a virtually continuous dimming. Alternatively or additionally, an amplitude modulation can be carried out here also.

Alternatively, the ground geometry can be detected with other (non-optical) means (e.g. by means of radar, GPS, etc.) and the luminance image can be defined independently therefrom.

In one development, the luminance image of the light reflected by the ground is recorded in at least one special state or mode (“test mode”), the time duration of which is shorter than a perception duration of the human eye. As a result, the test mode can be set to such a short time that the human eye advantageously does not perceive this. This may be provided in connection with semiconductor light sources, e.g. LEDs, which are correspondingly quickly switchable. Such a short time duration may, for example, be 0.04 seconds or less, e.g. 0.03 seconds or less, e.g. 0.015 seconds. Successive test modes are furthermore carried out, for example, at such a long time interval from one another that they cannot be perceived together by the human eye. Such a long time interval may, for example, be one second.

One test mode can be carried out, for example, so that the light sources are successively activated or partial areas illuminated by the light sources are illuminated successively. Alternatively or additionally, however, partial areas that are not superimposed on one another can also be illuminated and, if necessary, measured simultaneously.

In various embodiments, the test mode can be activated from a deactivated mode or from a different (illumination) mode of the headlamp.

In one test mode, a fixed predefined control of the light sources can be provided, e.g. a control with the same luminous intensity or brightness of all light sources. In a test mode of this type, the light sources can be operated, for example, at full luminous intensity (no dimming, 100%), at halved luminous intensity (50%) or a lower luminous intensity (e.g. 20%). In a different test mode, the light sources can be deactivated, which can also be referred to as “background measurement”. This offers that effects of the ambient lighting (streetlights, moon, etc.) can be taken into account.

In another design, the luminous intensities are defined and compared depending on the time of day, e.g. during twilight phases. As a result, the luminance can be adjusted according to a different perception of the human eye under different brightness conditions. To do this, the luminance sensor or the evaluation unit (computing unit) associated therewith can take account of a brightness perception of the human eye at different times of the day (e.g. daylight vision (photopic vision), twilight vision (mesopic vision) or night vision (scotopic vision).

In a further design, the luminance is adjusted according to a shift in position between the eyes of a driver of the vehicle and a luminance sensor defining the luminance. The effect is thereby achieved that a reference luminance distribution is particularly precisely adaptable to a driver.

In another further design, the luminous intensity of the light sources is adapted so that a roadway appears with higher luminance than a surrounding area of the roadway. This offers the effect that the driver's attention is directed toward the roadway, thereby increasing safety in road traffic.

In a further design, the luminous intensity is adapted alternately or alternatively according to the reference values of the illuminance and according to the reference values of the luminance. The effects of both method aspects are thus usable depending on the situation.

In one design, the luminous intensity is adapted according to the reference values of the illuminance if traffic objects are recognized in the ground area illuminated by the headlamp and the luminous intensity is adapted according to the reference values of the luminance if no traffic objects are recognized in the ground area illuminated by the headlamp. Traffic objects can be understood to mean, for example, obstacles, road users or pedestrians. This design exploits the fact that a highly homogeneous luminance enables a particularly high degree of vision comfort, but hinders an object recognition for a driver.

Alternatively or additionally, traffic objects can be highlighted by a marking function so that they appear with higher luminance.

In a general design, if traffic objects are recognized in the ground area which can be illuminated by the headlamp, these traffic objects are illuminated in such a way that they appear with higher luminance. This increases their recognizability and therefore road traffic safety.

In a further design, the comparison with respective reference values includes a comparison with at least one reference profile. This particularly simply enables an achievement of at least one predefined illuminance distribution or luminance distribution.

In order to increase the practicability of the method, the ground geometry or the surface topology or the reflection characteristics can be approximated by means of simple models, e.g. assuming the roadway as a plane or as plane sections with a variable tilt angle, for example relative to an optical axis of an AFS system (“Adaptive Frontlighting System”) or assuming illuminated objects as vertical planes.

In an additional development, a luminous intensity is adapted on the basis of data from a rain sensor. The data from the rain sensor may be used, for example, in wet conditions to reduce an illumination of horizontal surfaces to a greater extent than an illumination of vertical surfaces and/or in order to reduce the illuminance on the roadway.

Various embodiments provide a vehicle, having at least one headlamp with a plurality of individually controllable light sources which create different partial areas of a light emission pattern of the headlamp, wherein the vehicle is designed to carry out the method as described above.

In one design, the at least one headlamp has at least one field consisting of a plurality of individually controllable LEDs (controllable singly and/or in groups).

The vehicle has, for example, two headlamps whose light beams may at least partially overlap one another.

In another design, at least one headlamp is an ADB (“Advanced Driving Beam”) and/or an AFS (“Adaptive Frontlighting System”) headlamp or a part of an ADB and/or AFS system.

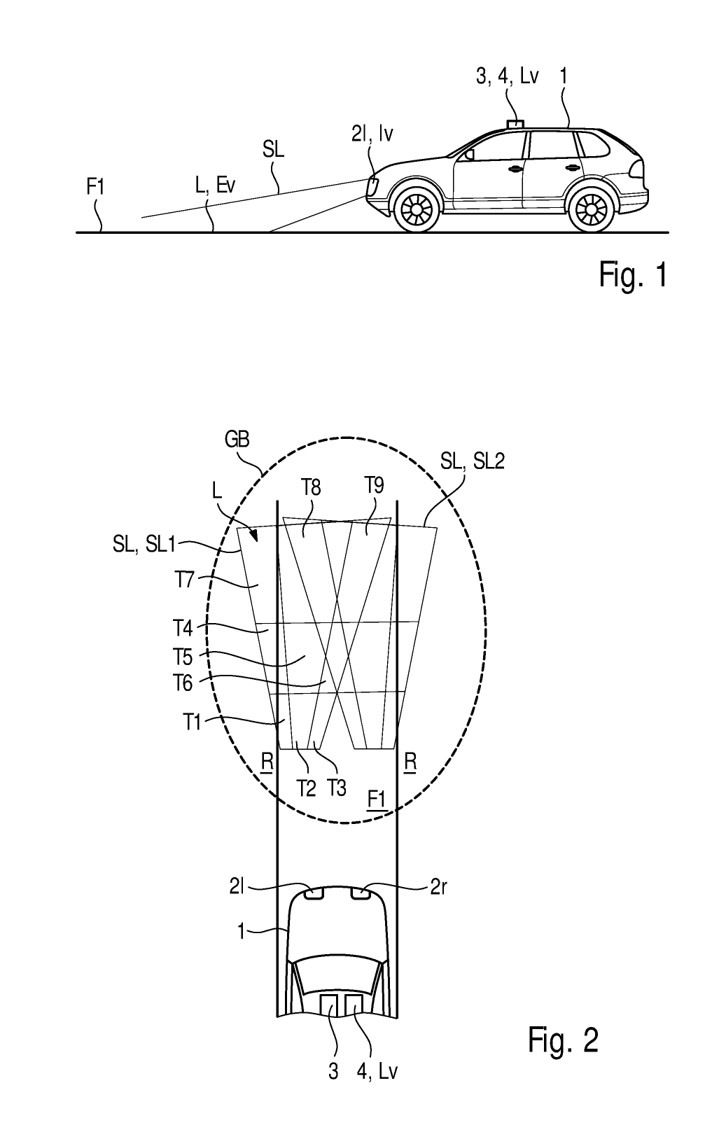

FIG. 1 shows a sectional representation in side view of a vehicle 1, e.g. a passenger vehicle, located on a first flat roadway F1 or roadway section. The direction of movement of the vehicle 1 runs in the figure from right to left on the first roadway F1. FIG. 2 shows the vehicle 1 in a top view together with a light emission pattern L emitted onto the first roadway F1.

The vehicle 1 has a left-side front headlamp 2l and a right-side front headlamp 2r. Both headlamps 2l, 2r have a plurality of individually controllable light sources in the form of light-emitting diodes (not illustrated) which may be disposed in each case in the form of an LED matrix. The LEDs are individually controllable (i.e. are controllable singly and/or in groups). Here, the front headlamps 2l and 2r can in each case have individually (3×3) controllable LEDs or LED groups.

The light beams SL1 and SL2 emitted by the LEDs or LED groups for each front headlamp 2l and 2r can create different partial areas T1 to T9 for each front headlamp 2l and 2r of the light emission pattern L. In FIG. 2, only the partial areas T1 to T9 for the left-side front headlamp 2l are denoted by reference numbers; partial areas for the right-side front headlamp 2r may be provided accordingly. The light beams SL1 and SL2 together form the headlamp light SL produced by the front headlamps 2l and 2r.

The vehicle 1 is furthermore configured to obtain a ground geometry or topology of a ground area GB, which can be illuminated by the headlamp SL, in the vicinity of the vehicle 1. Here, the ground area GB includes a section of the first roadway F1 and an edge area R laterally adjoining it. In order to obtain the ground geometry, the vehicle 1 can have a corresponding sensor 3, e.g. a laser scanner, a camera, a lidar, etc., and/or a receiver for externally stored ground geometry data. The ground geometry data stored externally in a database can be retrieved on the basis of the current position of the vehicle 1 and possibly its direction of travel, e.g. determined by a GPS sensor. Alternatively, the database is stored in the vehicle.

An illuminance Ev producible by each of the light sources on the ground area GB is calculated by means of the vehicle 1 (or alternatively by means of an external data processing device) using the obtained ground geometry, which corresponds here to a horizontal plane. This illuminance Ev may correspond to the illuminance on the respective partial areas T1 to T9, if necessary proportionately, taking account of overlapping partial areas. In one variant, the calculated illuminance Ev can be assumed as constant over the surfaces of the individual partial areas. In another variant, the calculated illuminance Ev may also change over the surfaces of the respective partial areas T1 to T9.

The calculated illuminances Ev can be compared with respective reference values and a luminous intensity Iv of the light sources can then be adjusted in order to achieve the associated reference values of the illuminance Ev. The reference values, e.g. for each of the partial areas T1 to T9, can be calculated and adjusted, if necessary proportionately, taking account of overlapping partial areas.

Additionally or alternatively, a luminance image of the ground area GB or of a part thereof can be recorded, e.g. by means of a luminance camera 4, and a partial image of the luminance image can be assigned to each light source, in particular using the previously obtained ground geometry. The partial images can then be compared with respective reference values and the luminous intensity Iv of the light sources can be adjusted to achieve the associated reference values of the luminance Lv. The luminances Lv, e.g. the reference values also, may be or may be defined as dependent on the time of day and/or dependent on weather conditions. The luminance Lv can be adjusted according to a shift in position between the eyes of a driver of the vehicle 1 and the luminance camera 4.

In one variant, the luminous intensity Iv can be adjusted alternately according to the reference values of the illuminance Ev and according to the reference values of the luminance Lv, e.g. in such a way that the luminous intensity Iv is adapted according to the reference values of the illuminance Ev if traffic objects are recognized in the ground area GB which can be illuminated by the headlamp light SL and the luminous intensity Iv is adapted according to the reference values of the luminance Lv if no traffic objects are recognized in the ground area GB which can be illuminated by the headlamp light SL. If traffic objects are recognized, they can be illuminated, in particular, in such a way that they appear with higher luminance Lv.

In one test mode, the partial areas T1 to T9 can be successively illuminated and, if necessary, measured. However, partial areas T1 to T9 which are not superimposed on one another can be simultaneously illuminated and, if necessary, measured.

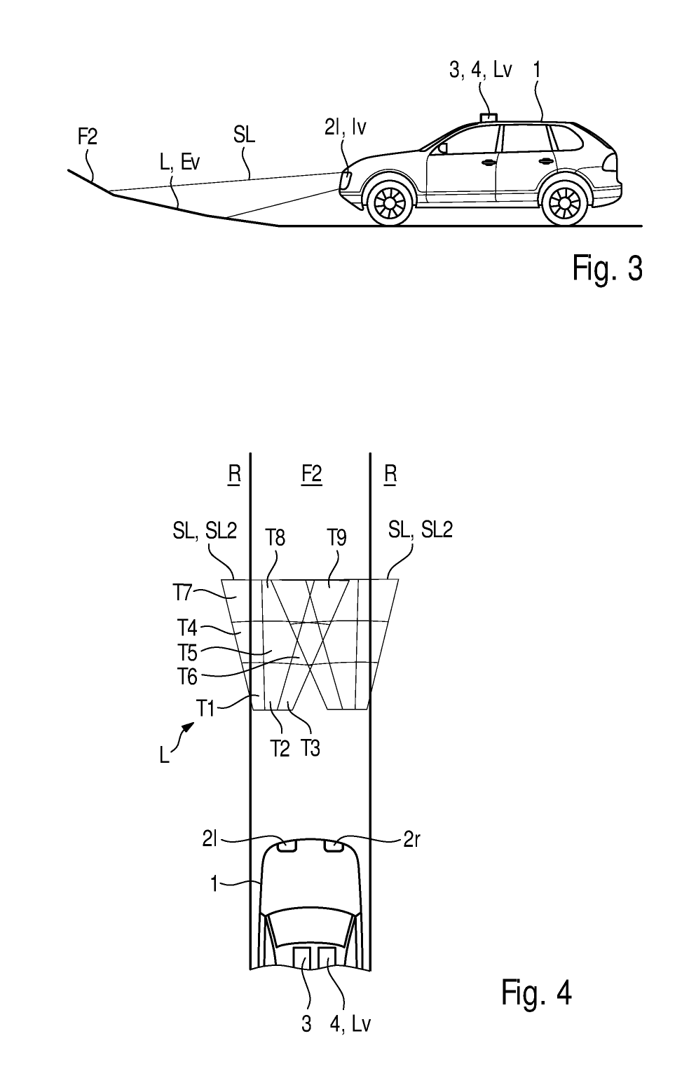

FIG. 3 shows a sectional representation in side view of the vehicle 1 on a second, ascending (upward-curving) roadway F2 or roadway section. FIG. 4 shows a top view of the vehicle 1 located on the second roadway F2 together with the light emission pattern L now emitted onto the second roadway F2.

The headlamp light SL now emits light at a narrower angle in relation to a surface normal (i.e. more steeply) onto the second roadway F2. The surfaces of the partial areas T1 to T9 are thereby reduced, as a result of which their illuminance Ev is increased in comparison with the horizontally flat carriageway FI with the same luminous intensity Iv. In order to keep the illuminance Ev constant, virtually independently from a curve of the carriageway F1, F2, the luminous intensity Iv is reduced to the extent that the illuminance Ev again takes on a reference value. In one variant, this correction can be made with no measurement, but solely by means of geometric calculations. Overlaps of partial areas T1 to T9, particularly of both headlamps 2l and 2r also, can also be taken into account here.

Although various embodiments have been illustrated and described in greater detail by means of the example embodiment shown, the embodiments are not limited thereto and other variations may be derived therefrom by the person skilled in the art without departing the protective scope of the invention.

The terms “a(n)”, “one”, etc. can be understood as singular or plural, particularly in the sense of “at least one” or “one or more”, etc., unless this is explicitly excluded, e.g. by the expression “precisely one”, etc.

An indication of numbers may also include precisely the indicated number as well as a customary tolerance range, unless this is explicitly excluded.

List of Reference Signs

Vehicle 1

Left-side front headlamp 2l

Right-side front headlamp 2r

Sensor 3

Luminance camera 4

Illuminance Ev

First roadway F1

Second roadway F2

Ground area GB

Luminous intensity Iv

Light emission pattern L

Luminance Lv

Edge area

Headlamp light SL

Light beam SL1

Light beam SL2

Partial areas T1-T9

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for adjusting a luminous intensity of headlamp light of a vehicle,
the vehicle comprising:
at least one headlamp producing the headlamp light;
the at least one headlamp comprising a plurality of individually controllable light sources which create different partial areas of a light emission pattern of the headlamp light;
the method comprising:
obtaining a ground geometry of a ground area which can be illuminated by the headlamp light in the vicinity of the vehicle;
calculating an illuminance producible by each of the light sources on the ground area using the obtained ground geometry;
comparing the calculated illuminances with respective reference values; and
adjusting a luminous intensity of the light sources to achieve the associated reference values of the illuminance.

2. The method of claim 1,
wherein a geometry of a roadway in front of the vehicle is obtained by querying a database with geometry data in the area of a current position of the vehicle.

3. The method of claim 1,
wherein the ground geometry is obtained by measuring it by means of the vehicle.

4. The method of claim 3,
wherein a ground geometry of a ground area which can be illuminated by the headlamp light is measured optically by means of the vehicle;
wherein a luminance image of the light reflected by the ground area is recorded;
wherein a partial image of the luminous image is assigned to each light source on the basis of the measured ground geometry;
wherein the partial images are compared with respective reference values; and
wherein a luminous intensity of the light sources is adjusted to achieve the associated reference values of the luminance.

5. The method of claim 4,
wherein the luminances are defined and compared depending on the time of day.

6. The method of claim 4,
wherein the luminance is adjusted according to a shift in position between the eyes of a driver of the vehicle and a luminance sensor defining the luminance.

7. The method of claim 4,
wherein the luminous intensity of the light sources is adjusted in such a way that a roadway appears with higher luminance than a surrounding area of the roadway.

8. The method of claim 4,
wherein the luminous intensity is adjusted alternately according to the reference values of the illuminance and according to the reference values of the luminance.

9. The method of claim 8,
wherein the luminous intensity is adjusted according to the reference values of the illuminance if traffic objects are recognized in the ground area which can be illuminated by the headlamp light; and
wherein the luminous intensity is adjusted according to the reference values of the luminance if traffic objects are recognized in the ground area which can be illuminated by the headlamp light.

10. The method of claim 4,
wherein, if traffic objects are recognized in the ground area which can be illuminated by the headlamp light, these traffic objects are illuminated in such a way that they appear with higher luminance.

11. The method of claim 1,
wherein the comparison with respective reference values comprises a comparison with at least one reference profile.

12. A vehicle, comprising;
at least one headlamp with a plurality of individually controllable light sources which create different partial areas of a light emission pattern of the headlamp light;
wherein the vehicle is configured to carry out a method, the method comprising:
obtaining a ground geometry of a ground area which can be illuminated by the headlamp light in the vicinity of the vehicle;
calculating an illuminance producible by each of the light sources on the ground area using the obtained ground geometry;
comparing the calculated illuminances with respective reference values; and
adjusting a luminous intensity of the light sources to achieve the associated reference values of the illuminance.

13. A method for adjusting a luminance in a vehicle,
the vehicle comprising at least one headlamp producing headlamp light, wherein the at least one headlamp has a plurality of individually controllable light sources which create different partial areas of a light emission pattern of the headlamp light;
the method comprising:
optically measuring a ground geometry of a ground area which can be illuminated by the headlamp light by means of the vehicle;
recording a luminance image of the light reflected by the ground area;
assigning a partial image of the luminous image to each light source on the basis of the measured ground geometry;
comparing the partial images with respective reference values; and
adjusting a luminous intensity of the light sources to achieve the associated reference values of the luminance.

14. The vehicle of claim 13,
wherein the at least one headlamp has at least one field consisting of a plurality of individually controllable light sources.

15. The vehicle of claim 14,
wherein the at least one headlamp has at least one field consisting of a plurality of individually controllable light emitting diodes.
